(19) United States
(12) Patent Application Publication
(10) Pub. No.: US 2024/0382895 A1
(43) Pub. Date: Nov. 21, 2024

(54) FACILITY FOR TREATING GAS COMPRISING A GAS COOLING APPARATUS

(71) Applicant: CSK INC., Yongin-si, Gyeonggi-do (KR)

(72) Inventors: Yun Soo Choi, Yongin-si, Gyeonggi-do (KR); Chan Kyoo Ko, Yongin-si, Gyeonggi-do (KR); Pil-Hyong Lee, Yongin-si, Gyeonggi-do (KR); Chun-Loon Cha, Yongin-si, Gyeonggi-do (KR); Jeong-Keun Lee, Yongin-si, Gyeonggi-do (KR); Ju Ha Kim, Yongin-si, Gyeonggi-do (KR); Hyun-A Shin, Yongin-si, Gyeonggi-do (KR)

(21) Appl. No.: 18/689,666

(22) PCT Filed: Aug. 23, 2022
(86) PCT No.: PCT/IB2022/057866

§ 371 Date: Mar. 6, 2024

(30) Foreign Application Priority Data
Sep. 16, 2021 (GB) 2113240.2

(51) Int. Cl. B01D 53/00; B01D 53/76; F28C 1/08

(52) U.S. Cl. CPC B01D 53/005; B01D 53/76; F28C 1/08; B01D 2258/0216

(57) ABSTRACT

A facility for treating gas includes a flow channel providing a passage through which a waste gas flows; a thermal decomposition unit for thermally decomposing the waste gas flowing through the flow channel; a quencher for cooling the waste gas passed through the thermal decomposition unit to a predetermined temperature; and a cooling chamber in communication with the flow channel such that the waste gas passed through the quencher is introduced into the cooling chamber, the cooling chamber accommodating a solid material for cooling therewithin.

### CROSS-REFERENCE OF RELATED APPLICATION

This application is a Section 371 National Stage Application of International Application No. PCT/IB2022/057866, filed Aug. 23, 2022, and published as WO 2023/042011 A1 on Mar. 23, 2023, the content of which is hereby incorporated by reference in its entirety and which claims priority of British Application No. 2113240.2, filed Sep. 16, 2021.

### FIELD

The present disclosure relates to a facility for treating gas comprising a gas cooling apparatus.

### BACKGROUND

Generally, during a manufacturing process in various industries such as a semiconductor manufacturing process, a process for manufacturing a display like LCD and OLED, etc., and solar cell manufacturing process, a waste gas including VOC (volatile organic compound), PFCs (perfluorinated compounds) and other substances is generated. Particularly, a plenty of waste gas is generated in a semiconductor etching process during the semiconductor manufacturing process.

Meanwhile, the waste gas generated during the semiconductor or display manufacturing process includes the gas that facilitates global warming, which is not easily decomposed and causes global warming and environmental pollution. For example, PFCs are one of the main causes of greenhouse effect and are not easily decomposed, and thus, they are required to be treated through a gas treating facility before discharged into the atmosphere.

A gas treating facility known in the prior art thermally decomposes the waste gas using plasma or flames in high temperature to treat the waste gas, and such thermally decomposed waste gas undergoes a certain cooling process to be discharged through an outlet duct in communication with the atmosphere. In addition, the gas treating facility includes a heat exchanger for reducing a temperature difference between the cooled waste gas and the outlet duct, so as to prevent the occurrence of dew condensation in the outlet duct.

However, when a gas cooling apparatus of the gas treating facility is used in the semiconductor manufacturing process, a powder is also generated during the semiconductor manufacturing process. This powder clogs a passage formed in the heat exchanger, thereby blocking a flow of the waste gas in the passage. As a result, the gas treating facility performs an additional process for cleaning the heat exchanger so that the passage of the heat exchanger can be unclogged, causing decrease in the efficiency of a semiconductor manufacturing process.

Furthermore, the gas treating facility using plasma and flames to thermally decompose the waste gas causes generation of acidic gas, and such generated acidic gas corrodes the heat exchanger. The heat exchanger can be coated to avoid such corrosion. However, heat transfer rate of the heat exchanger decreases due to the coating, and eventually, cooling efficiency of the waste gas decreases.

Accordingly, there is a need for an improved gas treating facility comprising a gas cooling apparatus, capable of preventing the occurrence of dew condensation and/or corrosion in the outlet duct, improving the efficiency of a semiconductor manufacturing process, and enhancing the efficiency for treating the waste gas.

The discussion above is merely provided for general background information and is not intended to be used as an aid in determining the scope of the claimed subject matter. The claimed subject matter is not limited to implementations that solve any or all disadvantages noted in the background.

### SUMMARY

An embodiment of the invention has been proposed in light of the background as described above and provides a facility for treating gas comprising a gas cooling apparatus capable of reducing a temperature difference between the waste gas undergone a cooling process and the outlet duct in order to prevent the occurrence of dew condensation in the outlet duct.

Further, an embodiment of the invention provides a facility for treating gas comprising a gas cooling apparatus capable of preventing corrosion of the outlet duct through which the waste gas is discharged and prevent the duct from being clogged.

Further, an embodiment of the invention provides a facility for treating gas comprising a gas cooling apparatus for which an additional cleaning process for or corrosion resistance of a heat exchanger in association with the powder needs not be considered.

Further, an embodiment of the invention provides a facility for treating gas comprising a gas cooling apparatus capable of improving efficiency of treating the waste gas.

According to an aspect of the invention, there is provided A facility for treating gas, comprising: a flow channel providing a passage through which a waste gas flows; a thermal decomposition unit for thermally decomposing the waste gas flowing through the flow channel; a quencher for cooling the waste gas passed through the thermal decomposition unit to a predetermined temperature; and a cooling chamber in communication with the flow channel such that the waste gas passed through the quencher is introduced into the cooling chamber, the cooling chamber accommodating a solid material for cooling therewithin.

In another aspect, there is provided a facility for treating gas which may further comprise a supply unit for supplying the solid material for cooling into the cooling chamber, the supply unit comprising: a storage compartment storing the solid material for cooling to be supplied into the cooling chamber and comprising at least one communication hole in communication with the cooling chamber; and an opening/closing portion configured to selectively allow the solid material for cooling accommodated in the storage compartment to move into the cooling chamber.

In another aspect, there is provided a facility for treating gas which may further comprise a purging unit capable of supplying a purge gas into the storage compartment to prevent the waste gas from being introduced into the storage compartment via the communication hole.

In another aspect, there is provided a facility for treating gas which may further comprise a controller for controlling the opening/closing portion to be in either of an open position in which the communication hole is opened to allow the solid material for cooling accommodated in the storage compartment to pass through the communication hole and a closed position in which the communication hole is closed, wherein, when the opening/closing portion is in the closed position, the controller may control the purging unit such that the purge gas in not supplied into the storage compartment.

In another aspect, there is provided a facility for treating gas wherein the supply unit may be disposed upper than the cooling chamber, and the cooling chamber is disposed at downstream of the flow channel.

In another aspect, there is provided a facility for treating gas wherein, at least one through hole may be formed at a lower part of the cooling chamber, wherein the through hole may be in communication with the flow channel and the water remained in the cooling chamber may be discharged from the cooling chamber via the through hole.

In another aspect, there is provided a facility for treating gas which may further comprise an outlet in communication with the cooling chamber such that the waste gas passed through the cooling chamber is introduced into the outlet.

In another aspect, there is provided a facility for treating gas which may further comprise a detection unit for measuring temperatures of the outlet and the waste gas flowing through the outlet; and a controller for controlling the supply unit to supply the solid material for cooling into the cooling chamber if a temperature of the waste gas flowing through the outlet is greater than a temperature of the outlet and a temperature difference between the outlet and the waste gas flowing through the outlet is equal to or greater than a predetermined value.

In another aspect, there is provided a facility for treating gas which may further comprise a detection unit for measuring an amount of the solid material for cooling accommodated in the cooling chamber; and a controller for controlling the supply unit to supply the solid material for cooling into the cooling chamber if the amount of the solid material for cooling measured by the detection unit is less than a pre-inputted threshold value.

In another aspect, there is provided a facility for treating gas which may further comprise a water tank accommodating water therein, wherein at least a portion of the flow channel may extend via the inside of the water tank, and the quencher and the cooling chamber may be respectively disposed on one side and the other side of the flow channel outside the water tank.

In another aspect, there is provided a facility for treating gas wherein the water tank may accommodate therein the water discharged from the cooling chamber, and the facility may further comprise a pump configured to guide the water accommodated in the water tank to the quencher.

In another aspect, there is provided a facility for treating gas wherein the cooling chamber may comprise an insulation for insulating the inside of the cooling chamber from the outside thereof.

In another aspect, there is provided a facility for treating gas wherein a temperature of a portion of the cooling chamber through which the waste gas is introduced into the cooling chamber may be within a range of 25° C. to 40° C., a temperature of the inside of the cooling chamber may be within a range of 0° C. to 15° C., and a temperature of a portion of the cooling chamber through which the waste gas is discharged from the chamber may be within a range of 15° C. to 25° C.

In another aspect, there is provided a facility for treating gas wherein the solid material for cooling may comprise one or more of ice and dry ice.

An embodiment of the invention can achieve an advantageous effect of reducing a temperature difference between the waste gas undergone a cooling process and the outlet in order to prevent the occurrence of dew condensation in the outlet.

Further, an embodiment of the invention can achieve an advantageous effect of preventing the outlet for the waste gas from being corroded and/or clogged.

Further, an embodiment of the invention can achieve an advantageous effect of eliminating the need for an additional cleaning process and the need to consider corrosion resistance in association with a powder generated during a preceding manufacturing process.

Further, an embodiment of the invention can achieve an advantageous effect of improving efficiency for treating the waste gas.

Further, an embodiment of the invention can achieve an advantageous effect of increasing the efficiency for operating a gas treating facility to improve the efficiency of a semiconductor manufacturing process.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The objects and features of the present disclosure will become apparent from the following description of embodiments, given in conjunction with the accompanying drawings, in which:

FIG. 1 is a perspective view showing a schematic configuration of a facility for treating gas according to a first embodiment of the invention.

FIG. 2 is a front view showing the facility for treating gas shown in FIG. 1.

FIG. 3 shows a flow path of a waste gas in the facility for treating gas shown in FIG. 2.

FIG. 4 is a perspective view showing a schematic configuration of a gas cooling apparatus of the facility for treating gas shown in FIG. 1.

FIG. 5 shows an opening/closing portion as shown in FIG. 4 moving into an open position.

FIG. 6 is a graph showing the temperature and humidity of a waste gas flowing through the path shown in FIG. 3.

FIG. 7 shows a block diagram schematically illustrating the facility for treating gas according to the first embodiment of the invention.

FIG. 8 is a front view showing a schematic configuration of a facility for treating gas according to a second embodiment of the invention.

### DETAILED DESCRIPTION

Hereinafter, specific embodiments for implementing the technical concept of the invention are described in detail with reference to the accompanying drawings.

Besides, in describing the invention, detailed descriptions on certain features or functions known in the art may be omitted if they are considered to render the gist of the invention vague.

It shall be understood that, as employed herein, the statement that an element “flows through”, “is discharged from”, “is introduced into” or “is connected to” another element may mean either that the element directly flows through, is discharged from, is introduced into or is connected to another element or that one or more intermediate parts are present therebetween.

The terms as employed herein are intended only to describe the specific embodiments of the invention, not to limit the disclosed concept of the invention. A singular expression is used to cover the corresponding plural expression, unless expressed otherwise in the context.

As employed herein, the term “comprise” or “include” shall specify particular characteristics, areas, essence, steps, operations, elements and/or components, but shall not exclude existence or addition of other characteristics, areas, essence, steps, operations, elements, components and/or ground.

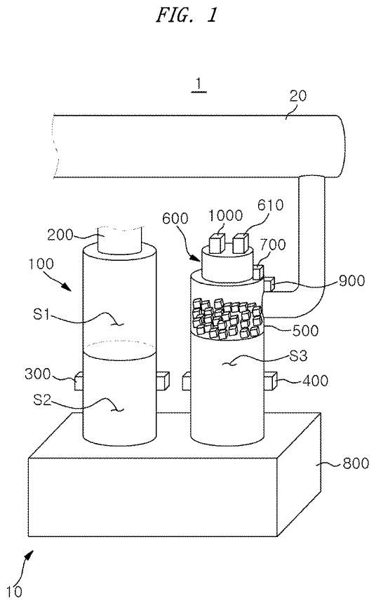

Further, as employed herein, directional phrases such as upper, lower and derivatives thereof are described with reference to the orientation shown in the drawings and may be expressed differently if the orientation is changed. Meanwhile, up-down direction as used herein may mean up-down direction as shown in FIGS. 1 to 5.

A facility for treating gas 1 comprising a gas cooling apparatus in accordance with a first embodiment of the invention performs gas treatment processes such as cooling and decomposing a waste gas generated during a manufacturing process in various industries, for example, a semiconductor manufacturing process, a process for producing a display such as a LCD or OLED, and a manufacturing process for a FPD (Flat Panel Display) or a solar cell. The use of the facility for treating gas 1 comprising a gas cooling apparatus is not limited hereto, and the facility for treating gas 1 comprising a gas cooling apparatus of the invention may be used in a wide variety of industries where corrosive gas and dust are produced. The waste gas, for example, may be acidic gas such as BCl₃, Cl₂, F₂, HBr, HCl, HF or the like or PFCs gas such as CF₄, CHF₃, C₂F₆, C₃F₈, C₄F₆, C₄F₈, C₅F₈, SF₆ or the like, which can be used to etch a surface of a wafer during a semiconductor manufacturing process. Further, the waste gas may be PFCs gas such as NF₃, C₂F₆, C₃F₆ or the like that is used in a cleaning process during chemical vapor deposition (CVD). Furthermore, the waste gas may include dust generated from gas used in the chemical vapor deposition such as SiH₄, WF₆, PH₃, SiH₄Cl₂, TEOS gas or the like being oxidized. As employed herein, it can be understood that the waste gas generated in the industries means a gas including one or more of dust, power and PFCs gas.

Hereinafter, a gas treating facility 1 in accordance with the first embodiment of the invention is described in detail with reference to the drawings.

Referring to FIG. 1, the gas treating facility 1 thermally decomposes the waste gas at a high temperature, and cools the thermally decomposed waste gas to discharge it outside. As employed herein, the gas treating facility 1 comprising a gas cooling apparatus may be simply referred to as a gas treating facility 1. The gas treating facility 1 may comprise a scrubber 10 and an outlet 20.

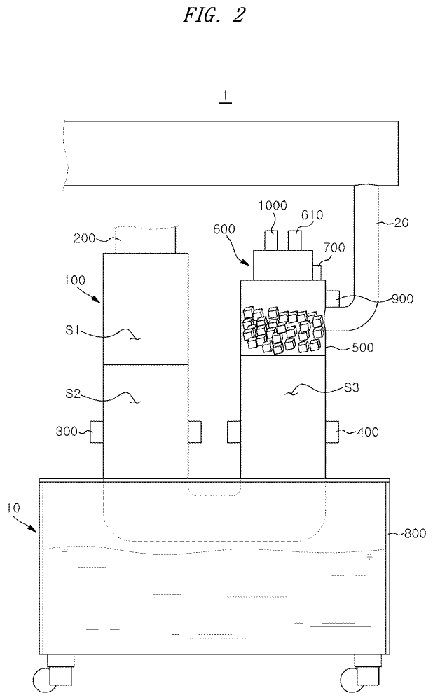

Referring to FIG. 2, the scrubber 10 thermally decomposes the waste gas generated during the etching or the chemical vapor deposition, and discharges the thermally decomposed waste gas outside via the outlet 20. The scrubber 10 may comprise a flow channel 100, a thermal decomposition unit 200, a quencher 300, a cleaning unit 400, a cooling chamber 500, a supply unit 600, a purging unit 700, a water tank 800, a detection unit 900 and a controller 1000.

The flow channel 100 provides a passage through which the waste gas flows. One end of the flow channel 100 is connected to a device in which the etching or chemical vapor deposition is carried out. As employed herein, it can be understood that upstream of the flow channel 100 refers to a side of the flow channel 100 connected to the device in which the etching or chemical vapor deposition is carried out. Further, the other end flow channel 100 is connected to the cooling chamber 500. As employed herein, it can be understood that downstream of the flow channel 100 refers to the other side of the flow channel 100 connected to cooling chamber 500. The flow channel 100 guides the waste gas treated in the thermal decomposition unit 200, the quencher 300 and the cleaning unit into the cooling chamber 500.

In the meantime, the flow channel 100 may extend such that at least a portion thereof extends via the inside of the water tank 800. Moreover, both ends of the flow channel 100 are placed outside the water tank 800. In the portion of the flow channel 100 disposed within the water tank 800, a plurality of holes (not shown) may be formed. For instance, the water introduced into the flow channel 100 may be discharged to the water tank 800 through the plurality of holes. The drawings according to the embodiment illustrate an example of the flow channel 100 having a U-shape, but the invention is not limited hereto.

Furthermore, the flow channel 100 may include a thermal decomposition region S1, a quenching region S2 and a cleaning region S3.

The thermal decomposition region S1 is defined as a region where the waste gas is thermally decomposed by the thermal decomposition unit 200, among several inner regions of the flow channel 100.

The quenching region S2 is defined, among the inner regions of the flow channel 100, as a region where the waste gas is cooled by the quencher 300. In addition, the waste gas passed through the quencher 300 has a first cooled temperature.

The cleaning region S3 is defined as a region where the waste gas is cleaned by the cleaning unit 400, among the inner regions of the flow channel 100. Further, the waste gas passed through the cleaning region S3 has a second cooled temperature which is lower than the first cooled temperature.

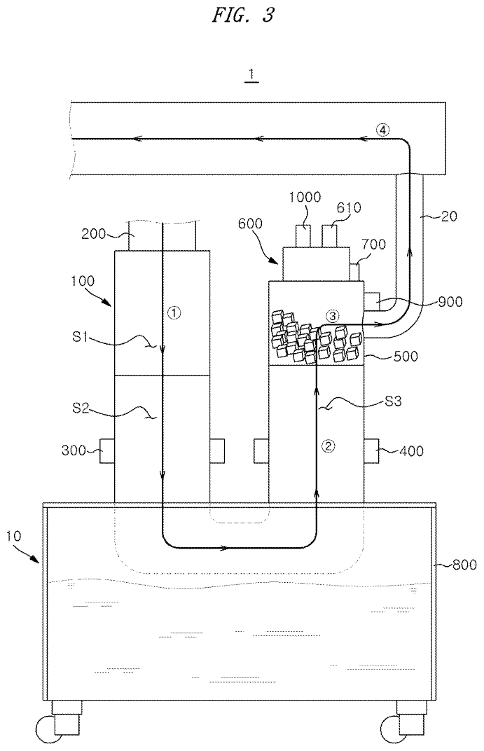

Referring to FIG. 3, the thermal decomposition region S1, the quenching region S2 and the cleaning region S3 may be sequentially formed along the direction in which the flow channel 100 extends. For example, the waste gas introduced into the flow channel 100 may sequentially pass through the thermal decomposition region S1, the quenching region S2 and the cleaning region S3 to flow to the cooling chamber 500.

The thermal decomposition unit 200 carries out thermal decomposition of the waste gas passing through the thermal decomposition region S1. The thermal decomposition unit 200 thermally decomposes the waste gas using plasma in high temperature or flames in high temperature. The waste gas which has been thermally decomposed by the thermal decomposition unit 200 flows towards the quenching region S2.

The quencher 300 cools the waste gas passing through the quenching region S2 to a certain temperature. The quencher 300 may spray water into the quenching region S2 to cool the waste gas. In other words, the quencher 300 may rapidly cool the waste gas by spraying water to hot waste gas. For example, the quencher 300 may spray water in low temperature with high pressure towards the waste gas using a nozzle. In addition, the quencher 300 may be supplied with water from the water tank 800. For instance, the water melted from a solid material in the cooling chamber 500 may be discharged to the water tank 800, and the quencher 300 may use the water accommodated in the water tank 800 to cool the waste gas. The waste gas which has been cooled to a certain temperature by the quencher 300 flows towards the cleaning region S3. Moreover, the quencher 300 may be disposed at the portion of the flow channel 100 placed outside the water tank 800.

The cleaning unit 400 cleans the waste gas passing through the cleaning region S3 and further cools the waste gas. The cleaning unit 400, in order to clean the waste gas, may contact the waste gas with a cleaning liquid so that water-soluble gas included in the waste gas can be absorbed in the cleaning liquid. For example, the water-soluble gas may include one or more of H₂SO₄, HF and HCl, and the cleaning liquid may be a mixed liquid of water and one or more of NaOH, KOH and H₂SO₄. The waste gas which has been cleaned by the cleaning unit 400 flows towards the cooling chamber 500.

The cooling chamber 500 accommodates a solid material for cooling therein such that the waste gas introduced into the cooling chamber 500 is cooled. As employed herein, the solid material for cooling is described as ice, but is not limited thereto. The solid material for cooling may be any solid material in low temperature such as ice, dry ice or the like which is capable of cooling the waste gas. Further, ice may be provided in a generally known shape, for example, sphere, cube, sliced or polyhedron. The cooling chamber 500 may comprise an insulation for insulating the inside thereof with its outside. That is, the cooling chamber 500 may be insulated from the outside via the insulation, so as to prevent the ice accommodated therein from being melted. The ice may be supplied to the cooling chamber 500 from the supply unit 600.

The cooling chamber 500 may be in communication with the flow channel 100 such that the waste gas is introduced into the cooling chamber 500. The cooling chamber 500 may be connected to the flow channel 100 on an upper side of the flow channel 100, and disposed at downstream of the flow channel 100. In other words, the flow channel 100 may be connected to the cooling chamber 500 on a lower side of the cooling chamber 500. In the meantime, the cooling chamber 500 and the quencher 300 may be respectively disposed on opposing sides of the flow channel 100. For instance, the cooling chamber 500 and the quencher 300 may be respectively disposed on different ends of the flow channel 100 placed outside the water tank 800. There may be formed at least one through hole 510 at the lower of the cooling chamber 500.

The through hole 510 may be in communication with the flow channel 100, and formed on the cooling chamber 500 such that water remained in the cooling chamber 500 is discharged from the cooling chamber 500 therethrough. For example, the waste gas passing through the flow channel 100 may be introduced into the cooling chamber 500 via the through hole 510. In addition, when the ice accommodated in the cooling chamber 500 melts, the water melted from the ice may be introduced into the flow channel 100 via the through hole 510.

Meanwhile, the cooling chamber 500 may be configured such that the waste gas is introduced into the cooling chamber 500 at an inflow temperature which is lower than or equal to 60° C. and the waste gas is discharged from the cooling chamber 500 at an outflow temperature which is lower than the inflow temperature. For example, the cooling chamber 500 may be configured such that a temperature of a portion of the cooling chamber 500 through which the waste gas is introduced into the cooling chamber 500 from the cleaning unit 400 is within a range of 25° C. to 40° C., a temperature of the inside of the cooling chamber 500 is within a range of 0° C. to 15° C., and a temperature of a portion of the cooling chamber 500 through which the waste gas is discharged from the cooling chamber 500 to the outlet 20 is within a range of 15° C. to 25° C. Further, the waste gas which has passed through the cooling chamber 500 has a third cooled temperature which is lower than the second cooled temperature.

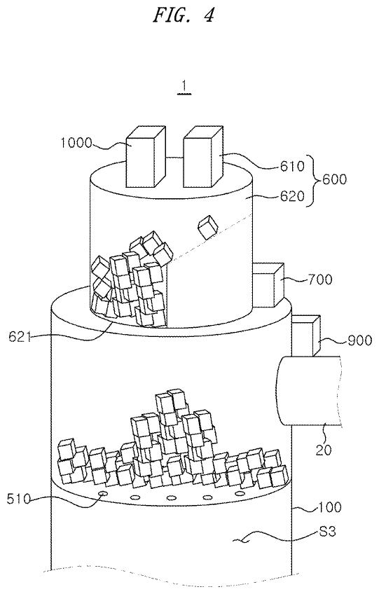

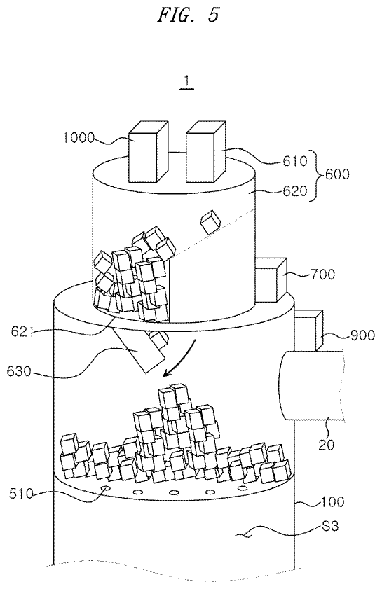

Referring to FIGS. 4 and 5, the supply unit 600 produces ice and supplies the produced ice into the cooling chamber 500. The supply unit 600 may be disposed on an upper side of the cooling chamber 500. Further, the operation of the supply unit 600 may be controlled by the controller 1000. As employed herein, the supply unit 600 may refer to a supply unit 600 for the solid material for cooling. Combined with the cooling chamber 500, the supply unit 600 may form a gas cooling apparatus (500, 600). The supply unit 600 may comprise a solid material producing portion 610, a storage compartment 620 and an opening/closing portion 630.

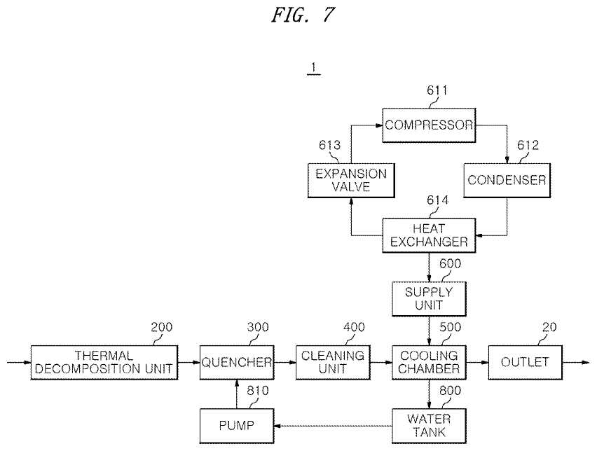

Referring to FIG. 7, the solid material producing portion 610 produces ice by exchanging heat with a refrigerant. For instance, the solid material producing portion 610 may be an air-cooled or water-cooled ice maker and may include a compressor 611, a condenser 612, an expansion valve 613 and a heat exchanger 614. Further, the solid material producing portion 610 may produce ice utilizing a refrigerant circulating the compressor 611, condenser 612, expansion valve 613 and heat exchanger 614. The solid material producing portion 610 may be supplied with water from the outside to produce ice. Moreover, the ice produced in the solid material producing portion 610 may be transferred to the storage compartment 620.

The storage compartment 620 prestores ice to be supplied to the cooling chamber 500. In other words, once the ice is produced, the storage compartment 620 temporarily stores the ice before the ice is transferred to the cooling chamber 500. Furthermore, the storage compartment 620 may be formed with at least one communication hole 621 which the ice accommodated in the storage compartment 620 passes through. As employed herein, the storage compartment 620 may refer to a storage compartment of the solid material for cooling. The communication hole 621 may be selectively opened and closed by the opening/closing portion 630.

The opening/closing portion 630 is configured to selectively allow the ice accommodated in the storage compartment 620 to move into the cooling chamber 500. The opening/closing portion 630 is configured to be in either of a closed position and an open position. As employed herein, the closed position means the position in which the opening/closing portion 630 closes the communication hole 621 so that the ice accommodated in the storage compartment 620 cannot pass through the communication hole 621 (see, FIG. 4). Further, as employed herein, the open position means the position in which the opening/closing portion 630 opens the communication hole 621 allowing the ice accommodated in the storage compartment 620 to pass through the communication hole 621 (see, FIG. 5).

The purging unit 700 prevents the waste gas from being introduced into the storage compartment 620 via the communication hole 621. The purging unit 700 may supply a purge gas to the storage compartment 620 in order to prevent the waste gas from flowing into the storage compartment 620. For example, the purge gas may include one or more of nitrogen (N₂), argon (Ar) and neon (Ne).

The water tank 800 accommodates therein the water discharged from the flow channel 100. For instance, water from melted ice in the cooling chamber 500 may be discharged from the cooling chamber 500 into the water tank 800 via the flow channel 100. In addition, the water introduced into the flow channel 100 by the quencher 300 and the cleaning unit 400 may be discharged into the water tank 800 via the flow channel 100.

In the meantime, the scrubber 10 may further comprise a pump 810 for guiding the water accommodated in the water tank 800 to the quencher 300. The water stored in the water tank 800 may be transferred to the quencher 300 via the pump 810.

The detection unit 900 measures the amount of the ice accommodated in the cooling chamber 500. For instance, the detection unit 900 may measure one or more of a volume, height, weight, etc. of the ice accommodated in the cooling chamber 500. This amount of ice measured by the detection unit 900 may be transmitted to the controller 1000. For another example, the detection unit 900 may measure temperatures of the outlet 20 and the waste gas flowing through the outlet 20. That is, the detection unit 900 may measure each of a temperature of the waste gas flowing through the outlet 20 and a temperature of the outlet 20. These temperature values measured by the detection unit 900 may be transmitted to the controller 1000. Meanwhile, the detection unit 900 may comprise, for example, one or more of a load cell, distance measuring sensor, volumeter and temperature sensor.

The controller 1000 controls the thermal decomposition unit 200, the quencher 300, the cleaning unit 400, the supply unit 600 and the purging unit 700. The controller 1000 may be implemented by an operational device comprising a microprocessor, measuring device such as a sensor or the like, and memory, and the detailed description of an implementation method thereof is omitted herein since it is obvious to the one skilled in the art.

The controller 1000 may control operation of the supply unit 600 based on the amount of the ice accommodated in the cooling chamber 500. For example, the controller 1000 may control the solid material producing portion 610 to produce ice if the amount of the ice accommodated in the cooling chamber 500 is less than a pre-inputted threshold value. Furthermore, the controller 1000 may control the opening/closing portion 630 to be in the open position if the amount of the ice accommodated in the cooling chamber 500 is less than a predetermined threshold value. The controller 1000 may receive the amount of the ice accommodated in the cooling chamber 500 from the detection unit 900.

Moreover, the controller 1000 may control the supply unit 600 based on a temperature difference between the outlet 20 and the waste gas flowing through the outlet 20. For instance, the controller 1000 may control the supply unit 600 to produce ice if the temperature of the waste gas flowing through the outlet 20 is higher than that of the outlet and the temperature difference therebetween is equal to or greater than a predetermined value. In addition, the controller 1000 may control the opening/closing portion 630 to be in the open position if the temperature of the waste gas flowing through the outlet 20 is higher than that of the outlet and the temperature difference therebetween is equal to or greater than a predetermined value. The controller 1000 may receive the respective temperatures of the outlet 20 and the waste gas flowing through the outlet 20 from the detection unit 900.

In the meantime, the controller 1000 controls the purging unit 700 to supply the purge gas into the storage compartment 620. For example, the controller 1000 may actuate the purging unit 700 in order to prevent the waste gas from being introduced into the storage compartment 620. For another example, the controller 1000 may stop the actuation of the purging unit 700 so that the purge gas is not supplied to the storage compartment, when the opening/closing portion 630 is in the closed position.

Hereinafter, operation and effects of the gas treating facility 1 according to the first embodiment of the invention are described with reference to FIGS. 3, 6 and 7.

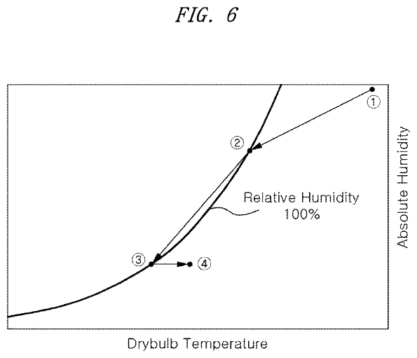

The gas treating facility 1 carries out thermal decomposition of the waste gas generated during an industry process. Further, the gas treating facility 1 cools the thermally decomposed waste gas to a certain temperature and then discharges it outside. The gas treating facility 1 thermally decomposes the waste gas passing through the thermal decomposition region S1 (see, (1) in FIG. 3) using plasma in high temperature or flames in high temperature. At this stage, the waste gas passing through the thermal decomposition region S1 is high in temperature, and is a dry gas with low relative humidity (see, \textcircled{1} in FIG. 6).

Afterwards, the gas treating facility 1 cools the waste gas passing through the quenching region S2 to the first cooled temperature using a gas cooled to a certain temperature. Further, the gas treating facility 1 sprays water into the cleaning region S3 to clean the waste gas passing through the cleaning region S3 (see, \textcircled{2} in FIG. 3), and cools the waste gas to the second cooled temperature. At this stage, the waste gas passing through the cleaning region S3 is high in temperature, and is a supersaturated gas (see, \textcircled{2} in FIG. 6).

Meanwhile, the gas treating facility 1 uses ice to cool the waste gas passing through the cooling chamber 500 (see, \textcircled{3} in FIG. 3) to the third cooled temperature. At this stage, the waste gas passing through the cooling chamber 500 is low in temperature, and is a supersaturated gas (see, \textcircled{3} in FIG. 6). Therefore, dew condensation occurs in the cooling chamber 500, and the waste gas passing through the cooling chamber 500 is condensed. That is, dew condensation occurs within the cooling chamber 500, not in the outlet 20.

The waste gas which has passed through the cooling chamber 500 is discharged outside through the outlet 20 (see, \textcircled{4} in FIG. 3). At this stage, the waste gas discharged outside via the outlet 20 is low in temperature, and is a dry gas with low relative humidity (see, \textcircled{4} in FIG. 6).

In the gas treating facility 1 in accordance with the first embodiment of the invention, the waste gas 400 which has passed through the cleaning unit 400 does not flow directly to the outlet 20, but flows to the outlet 20 via the cooling chamber 500.

As the waste gas is cooled in the cooling chamber 500, the difference between the temperature of the waste gas having passed through the cooling chamber 500 and the temperature of the outlet 20 is smaller than that between the waste gas having passed the cleaning unit 400 and the outlet 20. That is, the waste gas being condensed in the cooling chamber 500, not in the outlet 20 results in the effect of preventing the outlet 20 from being corroded. Further, clogging of the outlet 20, which occurs by condensate water produced in the outlet 20 due to dew condensation therein flocculating with the powder at the outlet 20, can also be prevented.

In addition, the gas treating facility 1 according to the first embodiment of the invention includes the cooling chamber 500 instead of a heat exchanger. As a result, when designing the facility, it is not necessary to consider a cleaning process for a heat exchanger and/or a corrosion resistive heat exchanger.

Accordingly, the gas treating facility 1 achieves the effect of improving treatment efficiency of the waste gas.

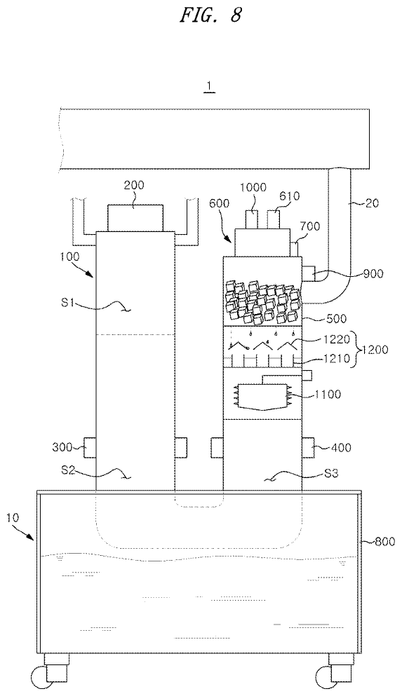

Meanwhile, according to a second embodiment of the invention, the gas treating facility 1 may further comprise an electric precipitator 1100 and a gas-liquid separation unit 1200. Hereinafter, referring to FIG. 8, the second embodiment of the invention is described. The second embodiment is described mainly in focus with differences to the aforementioned embodiment, and the identical elements and reference numerals may be referred to the descriptions for the aforementioned embodiment.

The electric precipitator 1100 removes the powder and dust included in the waste gas which has been cleaned in the cleaning unit 400. For example, the electric precipitator 1100 may induce corona discharge and electrify the power and dust in the waste gas to capture them.

The gas-liquid separation unit 1200 prevents the water discharged from the cooling chamber 500 from being introduced into the electric precipitator 1100. Further, the gas-liquid separation unit 1200 accommodates therein the water discharged from the cooling chamber 500, while allowing the waste gas flowing towards the cooling chamber 500 to pass therethrough. The gas-liquid separation unit 1200 may comprise one or more reservoirs 1210 and one or more separators 1220.

The reservoir 1210 accommodates therein the water discharged from the cooling chamber 500. A plurality of the reservoirs 1210 may be provided and the reservoirs 1210 may be disposed apart from each other in a direction perpendicular to the up-down direction.

The separator 1220 guides the water discharged from the cooling chamber 500 to the reservoir 1210. Moreover, the separator 1220 prevents the water discharged from the cooling chamber 500 from being introduced into the electric precipitator 1100. The separator 1220 may be positioned at the upper of the reservoir 1210.

The presently disclosed embodiments are considered in all respect to be illustrative and not restrictive, and should be construed to have the broadest scope according to the technical concept disclosed herein. The above-described embodiments can be embodied in various forms. Further, the above-described embodiment may be omitted, replaced, or changed in various forms without departing from the scope of the appended claims and the gist thereof, and it is obvious that these various modifications and alternatives to the disclosed embodiments should fall within the scope of the invention.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A facility for treating gas, comprising:
a flow channel providing a passage through which a waste gas flows;
a thermal decomposition unit for thermally decomposing the waste gas flowing through the flow channel;
a quencher for cooling the waste gas passed through the thermal decomposition unit to a predetermined temperature; and
a cooling chamber in communication with the flow channel such that the waste gas passed through the quencher is introduced into the cooling chamber, the cooling chamber accommodating a solid material for cooling therewithin.

2. The facility according to claim 1, further comprising a supply unit for supplying the solid material for cooling into the cooling chamber, the supply unit comprising:
a storage compartment storing the solid material for cooling to be supplied into the cooling chamber and comprising at least one communication hole in communication with the cooling chamber; and
an opening/closing portion configured to selectively allow the solid material for cooling accommodated in the storage compartment to move into the cooling chamber.

3. The facility according to claim 2, further comprising a purging unit capable of supplying a purge gas into the storage compartment to prevent the waste gas from being introduced into the storage compartment via the communication hole.

4. The facility according to claim 3, further comprising a controller for controlling the opening/closing portion to be in either of an open position in which the communication hole is opened to allow the solid material for cooling accommodated in the storage compartment to pass through the communication hole and a closed position in which the communication hole is closed,
wherein, when the opening/closing portion is in the closed position, the controller controls the purging unit such that the purge gas in not supplied into the storage compartment.

5. The facility according to claim 2, wherein the supply unit is disposed upper than the cooling chamber, and
the cooling chamber is disposed at downstream of the flow channel.

6. The facility according to claim 5, wherein, at least one through hole is formed at a lower part of the cooling chamber, wherein the through hole is in communication with the flow channel and the water remained in the cooling chamber is discharged from the cooling chamber via the through hole.

7. The facility according to claim 2, further comprising an outlet in communication with an upper part of the cooling chamber such that the waste gas passed through the cooling chamber is introduced into the outlet.

8. The facility according to claim 7, further comprising:
a detection unit for measuring temperatures of the outlet and the waste gas flowing through the outlet; and
a controller for controlling the supply unit to supply the solid material for cooling into the cooling chamber if a temperature of the waste gas flowing through the outlet is greater than a temperature of the outlet and a temperature difference between the outlet and the waste gas flowing through the outlet is equal to or greater than a predetermined value.

9. The facility according to claim 2, further comprising:
a detection unit for measuring an amount of the solid material for cooling accommodated in the cooling chamber; and
a controller for controlling the supply unit to supply the solid material for cooling into the cooling chamber if the amount of the solid material for cooling measured by the detection unit is less than a pre-inputted threshold value.

10. The facility according to claim 1, further comprising a water tank accommodating water therein,
wherein at least a portion of the flow channel extends via the inside of the water tank, and
the quencher and the cooling chamber are respectively disposed on one side and the other side of the flow channel outside the water tank.

11. The facility according to claim 10, wherein the water tank accommodates therein the water discharged from the cooling chamber,
the facility further comprising a pump configured to guide the water accommodated in the water tank to the quencher.

12. The facility according to claim 1, wherein the cooling chamber comprises an insulation for insulating the inside of the cooling chamber from the outside thereof.

13. The facility according to claim 1, wherein a temperature of a portion of the cooling chamber through which the waste gas is introduced into the cooling chamber is within a range of 25° C. to 40° C., a temperature of the inside of the cooling chamber is within a range of 0°° C. to 15° C., and a temperature of a portion of the cooling chamber through which the waste gas is discharged from the cooling chamber is within a range of 15° C. to 25° C.

14. The facility according to claim 1, wherein the solid material for cooling comprises one or more of ice and dry ice.
